(19) United States
(12) Patent Application Publication
(10) Pub. No.: US 2002/0120782 A1
(43) Pub. Date: Aug. 29, 2002

(54) Transparent proxying enhancement

(76) Inventors: Douglas Dillon, Gaithersburg, MD (US); Frank Kelly, Walkersville, MD (US)

Correspondence Address: Hughes Electronics Corporation, Patent Docket Administration, Bldg. 1, Mail Stop A106, P.O. Box 956, El Segundo, CA, 90245-0956, US

(21) Appl. No.: 10/084,790

(22) Filed: Feb. 25, 2002

Related U.S. Application Data
(60) Provisional application No. 60/271,405, filed on Feb. 26, 2001.

(51) Int. Cl. G06F 15/16

(52) U.S. Cl. 709/246; 709/245; 709/203

(57) ABSTRACT

An approach for providing a proxy service is disclosed. A message from an application that supports browsing is received. The message is identified as invoking the proxy service. The message is selectively forwarded to a proxy agent (e.g., a HyperText Transfer Protocol (HTTP) proxy or a Domain Name Service (DNS) proxy) that is configured to provide the proxy service. The forwarding of the message is transparent to the application. The present invention has particular applicability to a satellite network.

### CROSS-REFERENCES TO RELATED APPLICATIONS

This application is related to, and claims the benefit of the earlier filing date under 35 U.S.C. §119(e) of, U.S. Provisional Patent Application (Serial No. 60/271,405), filed Feb. 26, 2001, entitled “Transparent Proxying Enhancement,” the entirety of which is incorporated herein by reference.

### BACKGROUND OF THE INVENTION

1. Field of the Invention

The present invention relates to a communication system, and is more particularly related to providing a proxy mechanism in data network.

2. Discussion of the Background

The entrenchment of data networking into the routines of modern society, as evidenced by the prevalence of the Internet, particularly the World Wide Web (the “Web”), has placed ever-growing demands on service providers to continually improve network performance. To meet this challenge, service providers have invested heavily in upgrading their networks to increase system capacity (i.e., bandwidth). In many circumstances, such upgrades may not be feasible economically or the physical constraints of the communication system does not permit simply “upgrading.” Accordingly, service providers have invested in developing techniques to employ proxy services to enhance the performance of their networks.

Proxy servers are deployed in data networks, in part, to reduce user response times. A proxy server, for example, may store information that is routinely accessed by a client (e.g., personal computer (PC)). Such a proxy server is referred to as a caching proxy server. In this manner, unnecessary traversal of various segments of a network to retrieve information that is requested by the client is avoided. Proxy servers have also been used, particularly in satellite communications networks and wireless networks, to reduce response time and network utilization by converting from the applications native protocol (e.g. HTTP) to a protocol which is optimized to operate over the satellite or wireless network. Such a protocol typically defeats the response time performance shortcomings of the native protocol and provides compression and other measures to reduce network utilization. Such an optimizing proxy server typically communicates with an upstream proxy server located at the far end of the satellite or wireless network. This upstream proxy server converts the optimized protocol back into the native protocol thereby allowing communications with unmodified servers on the conventional network. As is well known, a combination caching and optimizing proxy server may be used to provide the benefits of both the caching and optimizing proxy server. Such a combination caching and optimizing proxy server is described in my TBD patent application which is incorporated into this application by reference. Conventionally, to obtain the advantages of the proxy services, the client software requires modification to redirect the requests to the proxy server.

Unfortunately, the above conventional approach has a number of attendant drawbacks, particularly with respect to the popular Internet application of web browsing. One drawback is that users can bypass the proxying (which may increase their inbound network utilization by as much as ten-fold) by not executing the necessary configurations. Further, the configuration process itself may cause usability problems, particularly when a user switches between Internet Service Providers (ISPs) for Internet access.

Based on the foregoing, there is a clear need for improved approaches to providing proxy services. There is also a need to enhance network performance, without significant reconfiguration of network elements (e.g., clients). Therefore, an approach for optimizing network performance using a proxy architecture is highly desirable.

### SUMMARY OF THE INVENTION

The present invention addresses the above stated needs by providing a proxy architecture that enhances network performance by transparently routing HTTP (Hypertext Transfer Protocol) and DNS (Domain Name Server) look-ups to corresponding proxies. A Layer 4 (i.e., transport layer) switch is provided to route an HTTP request or a DNS request to the respective HTTP proxy and DNS proxy; the Layer 4 switch supports forwarding of the requests that is transparent to the browser, which originates such requests. The above arrangement advantageously enhances system performance, while avoiding the need to pre-configure client software.

According to one aspect of the invention, a method for providing a proxy service is disclosed. The method includes receiving a message from an application that supports browsing. The message is identified as invoking the proxy service. The method also includes selectively forwarding the message to a proxy agent configured to provide the proxy service, wherein the forwarding of the message is transparent to the application.

According to another aspect of the invention, a network apparatus for providing a proxy service is disclosed. The apparatus includes switching logic that is configured to receive a message from an application that supports browsing and to identify the message as invoking the proxy service. The switching logic selectively forwards the message to a proxy agent configured to provide the proxy service, in which the forwarding of the message is transparent to the application.

According to another aspect of the invention, a communication system for supporting a proxy service is disclosed. The system includes a host loaded with an application that supports browsing; the application outputs a message that requests information. The system also includes a network element that is configured to receive the message from the host and to identify the message as invoking a proxy agent to perform the proxy service. The network element includes a switching mechanism to selectively forward the message to the proxy agent, in which the forwarding of the message is transparent to the application of the host.

According to another aspect of the invention, a computing device for supporting a proxy service is disclosed. The device includes means for receiving a message identified as invoking the proxy service from an application that supports browsing. The device also includes means for selectively forwarding the message to a proxy agent configured to provide the proxy service, wherein the forwarding of the message is transparent to the application.

In yet another aspect of the present invention, computer-readable medium carrying one or more sequences of one or more instructions for providing a proxy service is disclosed. The one or more sequences of one or more instructions including instructions which, when executed by one or more processors, cause the one or more processors to perform the step of receiving a message from an application that supports browsing, wherein the message is identified as invoking the proxy service. Another step includes selectively forwarding the message to a proxy agent configured to provide the proxy service, wherein the forwarding of the message is transparent to the application.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of a communication system utilizing a proxy architecture, in accordance with an embodiment of the present invention;

FIG. 2 is a diagram of an architecture for providing transparent proxying in a host computer, in accordance with an embodiment of the present invention;

FIGS. 3A and 3B are diagrams of exemplary architectural approaches for providing transparent proxying, in accordance with an embodiment of the present invention;

FIG. 4 is a flow diagram of a Domain Name Service (DNS) request in a transparent proxying architecture, in accordance with an embodiment of the present invention;

FIG. 5 is a flow diagram of a connection establishment request via a HyperText Transfer Protocol (HTTP) in a transparent proxying architecture, in accordance with an embodiment of the present invention; and

FIG. 6 is a diagram of a computer system that can perform transparent proxying, according to an embodiment of the present invention.

### DESCRIPTION OF THE PREFERRED EMBODIMENTS

In the following description, for the purposes of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the present invention.

Although the present invention is discussed with respect to a satellite-based broadband service system (e.g., DIRECWAY® by Hughes Network Systems) and the HTTP and DNS protocols, the present invention has applicability to other data networks and equivalent protocols.

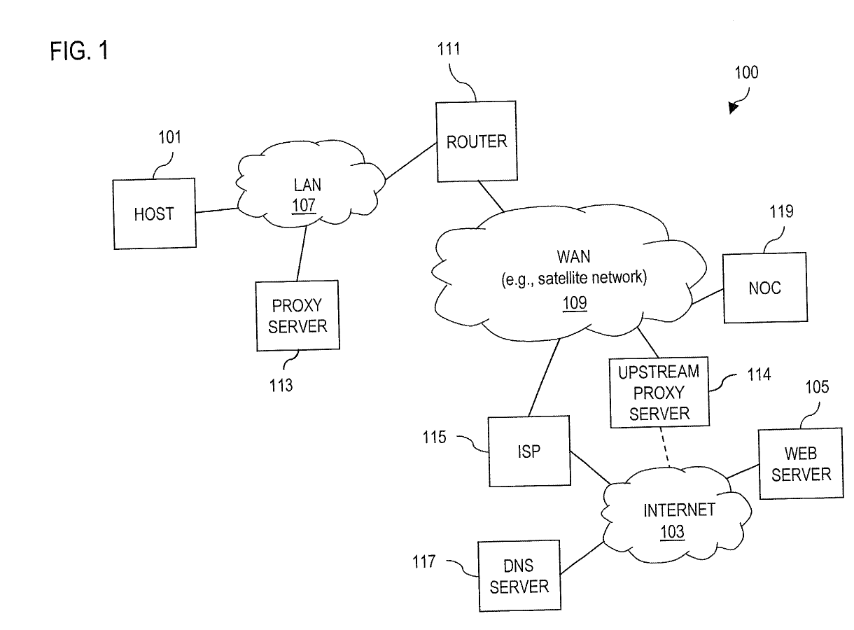

FIG. 1 shows a diagram of a communication system utilizing a proxy architecture, in accordance with an embodiment of the present invention. A communication system 100 supports enhanced system performance for access by a host 101 to the Internet 103. The host 101 may be any computing device, such as a personal computer (PC), a workstation, web enabled set-top boxes, wireless PDA, webified cell phone, web appliances, and etc. The phenomenal growth of the Web is attributable to the ease and standardized manner of “creating” a web page, which can possess textual, audio, and video content. Web pages are formatted according to the Hypertext Markup Language (HTML) standard which provides for the display of high-quality text (including control over the location, size, color and font for the text), the display of graphics within the page and the “linking” from one page to another, possibly stored on a different web server. Each HTML document, graphic image, video clip or other individual piece of content is identified, that is, addressed, by an Internet address, referred to as a Uniform Resource Locator (URL). As used herein, a “URL” may refer to an address of an individual piece of web content (HTML document, image, sound-clip, video clip, etc.) or the individual piece of content addressed by the URL. When a distinction is required, the term “URL address” refers to the URL itself while the terms “web content”, “URL content” or “URL object” refers to the content addressed by the URL.

The host 101 is loaded with a web browser (e.g., Microsoft Internet Explorer, Netscape Navigator) to access the web pages that are resident on a web server 105; collectively the web pages and the web server 105 denote a “web site.” The host 101, in this example, is attached to a local area network (LAN) 107 and communicates over a wide area network (WAN) 109 through a router 111 (or equivalent network device). A proxy server 113 may be provided to increase system performance by supporting such functions as HyperText Transfer Protocol (HTTP) proxying and Domain Name Service (DNS) proxying. When this proxy server 113 is an optimizing proxy server, it communicates with an upstream proxy server 114, which may be connected to the portion of the WAN 101 near its ISP connection 115; alternatively, the upstream proxy server 114 may be attached to the Internet 103.

HTTP is an application level protocol that is employed for information transfer over the Web. RFC (Request for Comment) 2618 specifies this protocol and is incorporated herein in its entirety. As will be described in more detail later, these proxy services (or functions) may also be resident entirely within the host 101 or within the router 111. The WAN 109, which may be a satellite network or other wireless network, has connectivity to an Internet Service Provider (ISP) 115. The ISP 115 connects the WAN 109 to the Internet 103.

In a typical transaction without the benefit of the current invention, the user enters or specifies a URL to the web browser of the host 101, which in turn requests a URL from the web server 105. The host 101 may need to retrieve an Internet Protocol (IP) address corresponding to a domain name of the URL from a domain name service (DNS) server 117. Such a domain name lookup takes a traversal of the WAN 109 which, for some networks, is an extra, noticeable and annoying delay. The web server 105 returns an HTML page, which contains numerous embedded objects (i.e., web content), to the web browser. Upon receiving the HTML page, the web browser parses the page to retrieve each embedded object. The retrieval process requires the establishment of separate communication sessions (e.g., TCP (Transmission Control Protocol) connections) to the web server. That is, after an embedded object is received, the TCP connection is torn down and another TCP session is established for the next object. Given the richness of the content of web pages, it is not uncommon for a web page to possess over 30 embedded objects; thereby consuming a substantial amount of network resources, but more significantly, introduces delay to the user. The establishment of the TCP connection takes one WAN 109 round trip traversal and then the requesting of the URL and receiving its response takes another round trip traversal. Delay is of a particular concern in the system 100 because the WAN 109, in an exemplary embodiment, is a satellite network, in that the network latency of the satellite network is conventionally longer than terrestrial networks. To minimize such delay, the system 100 provides a transparent proxy service, which supports an HTTP proxy and/or a DNS proxy.

The host 101's web browser may be configured to either access URLs directly from the web server 105 or from the proxy server 113, which acts as a HTTP proxy. As discussed above, a URL specifies an address of an “object” in the Internet 103 by explicitly indicating the method of accessing the resource. A representative format of a URL is as follows: http://www.hns.com/homepage/document.html. This example indicates that the file “document.html” is accessed using HTTP. The proxy server 113 acts as an intermediary between one or more browsers and many web servers (e.g., server 105). The web browser requests a URL from the proxy server 113 which in turn “gets” the URL from the addressed web server 105. The proxy server 113 itself may be configured to either access URLs directly from the web server 105 or from an upstream proxy server 113a. When the browser is configured to access URLs via a proxy server 113, the browser does not need to do a DNS lookup of the URL's web server because it is requesting the URL from the proxy server and need only be able to contact the proxy server. The HTTP proxy server 113, according to one embodiment of the present invention, stores the most frequently accessed URLs. When the web server 105 delivers a URL to the proxy server 113, the web server 105 may deliver along with the URL an indication of whether the URL should not be cached and an indication of when the URL was last modified.

According to one embodiment of the present invention, the proxy server 113 may support multicast pre-loading of its cache. The multicast preloading of HTTP content is described in my TBD Webcast Patent Application and Multicast Preload patent applications which are incorporated into this patent application by reference. IP multicasting can be used to transmit information from a Network Operations Center (NOC) 119 to a number of the proxy servers, including the proxy server 113. Multicast preloading of the DNS cache is detailed in a co-pending patent application (Ser. No. 09/863,157) to Fletcher et al, entitled “Caching Address Information in a Communications System,” filed on May 23, 2001, which is incorporated herein in its entirety.

The process of performing transparent proxying, as the label suggests, is transparent to the client software and is more fully described below. Consequently, this transparency advantageously eliminates the need to pre-configure the client software. A subtle, but important point that is not widely known is that because the proxying of HTTP is transparent to the browser, the browser still has to perform a DNS lookup to convert a URL's web server domain name into an IP address. One of the key benefits of the present invention is to reduce or eliminate the response time impact of this DNS lookup thereby making the response time performance of transparent proxying nearly as good as the response time with transparent proxying.

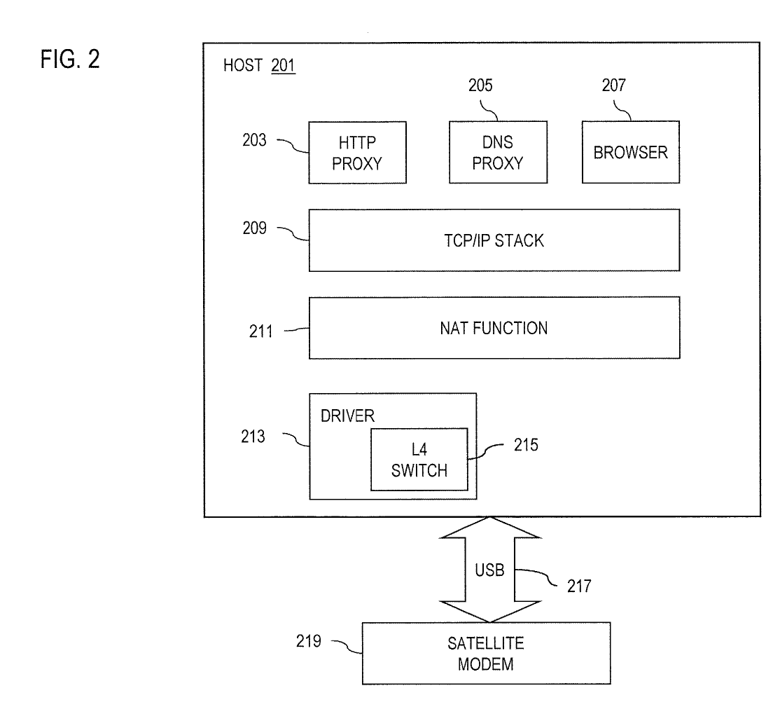

FIG. 2 shows a diagram of an architecture for providing transparent proxying in a host computer, in accordance with an embodiment of the present invention. In this example, the transparent proxy services are implemented in a host 201, such as a personal computer (PC). The host 201 may operate in either a one-way satellite system or a two-way satellite system. In the one-way system, the downstream channel is over the satellite network, while the upstream channel (i.e., return channel) is provided over a terrestrial network (e.g., dial-up modem); however, the two-way system has both upstream and downstream channels over the satellite network. The host 201 couples to a satellite modem 217 via a communications interface 219, which in an exemplary embodiment is a Universal Serial Bus (USB) interface. The transparent proxy services provide transparently routing of HTTP and DNS lookups.

According to one embodiment of the present invention, the host 201 includes two proxy agents: a HTTP Proxy 203 and a DNS proxy 205. A web browser 207 is loaded within the host 201 for retrieving HTTP objects (e.g., text, graphics, etc.) from a web server (not shown). The host 201 utilizes, in an exemplary embodiment, a TCP/IP stack 209 as well as a network address translation (NAT) function layer 211. The NAT layer 211 provides address translation between a private network (i.e., a stub domain), such as a local area network, and a public network, such as the global Internet. Address translation is necessary when the LAN utilizes unregistered IP addresses, for example. The NAT layer 211 is detailed in Internet Engineering Task Force (IETF) Request for Comment (RFC) 1631, entitled “The IP Network Address Translator (NAT),” which is incorporated herein by reference in its entirety. Further, the NAT layer 211, according to an embodiment of the present invention, is utilized as a firewall for blocking undesired traffic.

In this example, a driver 213 (e.g., Ethernet driver) has a Layer 4 switch function 215 to the driver 213. This driver 213 may also be used to provide multicast preloaded cache entries to the HTTP proxy 203 and/or DNS proxy 205. As used herein, Layer 4 refers to the transport layer of the OSI (Open Systems Interconnection) model; it is recognized, however, that Layer 4 may denote any equivalent protocol.

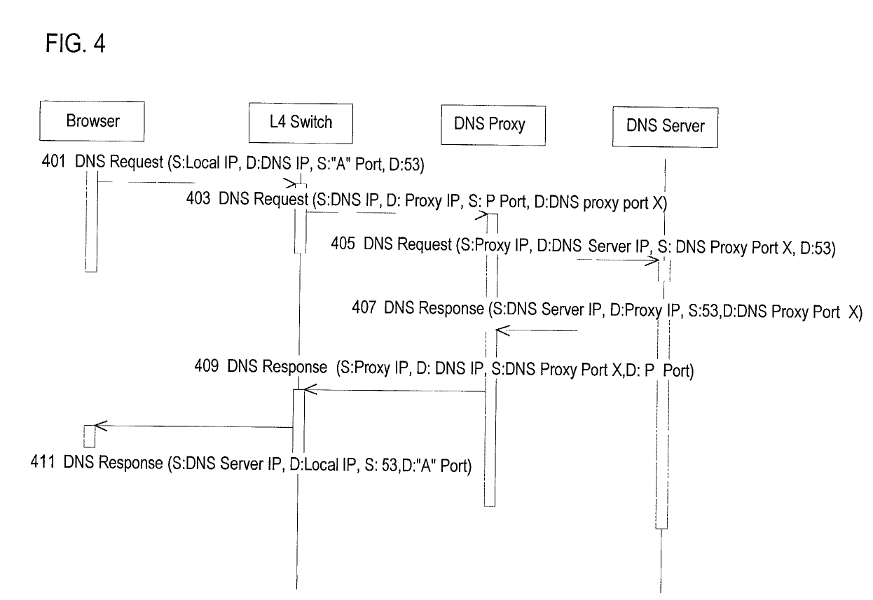

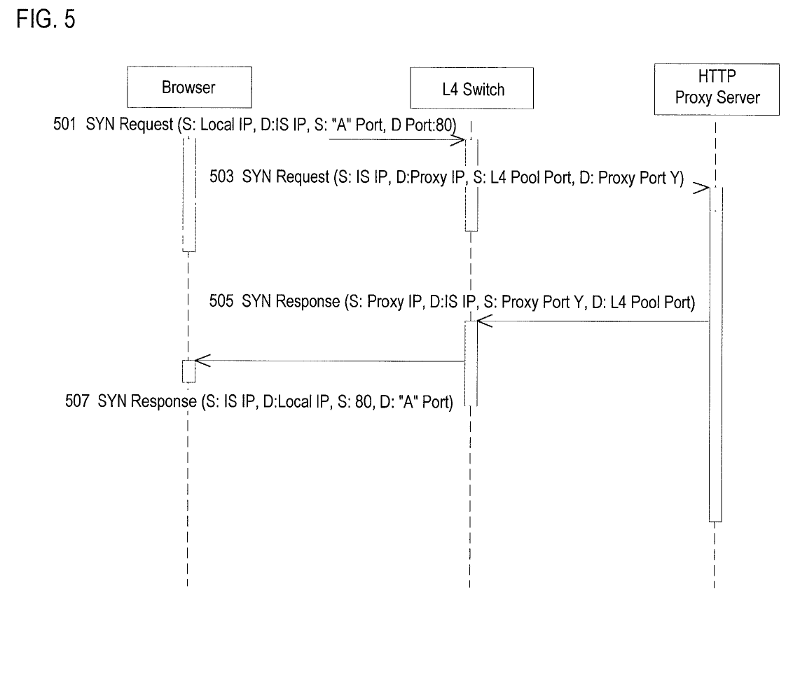

The Layer 4 switch function 215 routes all domain name server lookups (i.e., DNS requests) and HTTP requests traversing the driver 213 up through the stack to their respective proxies 205 and 203. The Layer 4 switch function 215 identifies these requests by examining the port number of the packets, and modifies the addresses and ports to redirect the request packets to the appropriate proxy 205 and 203. It performs a similar function of modifying packet address and port fields of response packets from the proxies 205 and 203 to route those responses back to the browser 207. To accomplish this, the Layer 4 switch function 215 also maintains the TCP connection control block. This operation by the Layer 4 switch function 215 is more fully described with respect to FIGS. 4 and 5. It should be observed that while the HTTP proxy 203 relies on TCP, the DNS proxy 205 is based upon the User Datagram Protocol (UDP). Despite the difference in transport protocol used in these two proxies, the Layer 4 switch function 215 is conceptually the same for both HTTP requests and DNS requests. These requests are originated by the browser 207. They may also be originated by an application on another local area network when for example, when Microsoft Internet Connection Sharing (or SatServ or some other NAT-based gateway software) is installed on host 201 (not shown in FIG. 2). No reconfiguration of other LAN client's browser or DNS configuration is required to achieve the performance seen by the PC's own browser 207.

All HTTP accesses are routed through the HTTP proxy 203 to ensure that bandwidth savings mechanisms are always employed. On a cache miss, the proxies forward a request through over the WAN to the NOC (Network Operations Center) using either pure TCP, or if HTTP proxy 203 is an optimizing proxy using a protocol which is optimized for the wide area network being used.

Further, the transparent proxy services include the NOC functions associated with the multicast transmission of DNS cache entries; this includes a number of entities. For example, a Cache Entry Transmitter periodically multicasts at a low (e.g., 1200 bps), fixed bit rate DNS cache entries from a list of DNS names. In an exemplary embodiment, this entity may be an Microsoft NT service residing on a server within the satellite network's hub earth station (i.e., Network Operations Center 119). Another entity is a Cache List Generator, which receives per-URL information from either the proxy servers or a domain name server or other device and creates the list of DNS entries to be multicast by selecting the N most popular names—where N is configurable. The list generator runs on the same platform as the service information transmitter and is internally one-for-one redundant.

As mentioned, the transparent proxy services increase the usability of client software by eliminating the need to configure the browser 207 in order to achieve the response time and bandwidth reduction benefits of HTTP proxying. Conventionally, automatic configuration of the browser in existing client software has been required, which, as noted previously, has numerous drawbacks.

By contrast to the traditional approach, the transparent proxy services effectively address the above noted drawbacks by transparently routing HTTP and DNS lookups. Additionally, the transparent proxy services support multicast preloading of the DNS cache (not shown), which eliminates the response time impact of most of these DNS lookups. Even non-preloaded DNS caching, with long cache entry expiration periods, will sharply reduce impact of DNS lookups. It is noted that transparent proxying and DNS caching may be automatically configured so that they occur only when their associated proxies are operational.

The Network Operations Center (NOC) supports DNS caching by providing various functions. The NOC is responsible for automatically generating the DNS addresses that are to be preloaded into caches; these DNS addresses may follow any number of criteria, such as the most popular DNS addresses. The DNS addresses are then multicast by the NOC to the DNS cache. DNS caching pass through DNS lookups when a cache lookup fails, perhaps due to a DNS multicast preload outage. The DNS cache is configured to operate as a caching DNS cache even when there is no multicast preload. It is noted that the DNS cache interoperates with any other DNS servers either local to the host 201 or on the LAN; the DNS cache may, under such circumstances, pass requests from such DNS servers transparently to the NOC without providing any caching benefits. The Network Operations Center (NOC) also supports, in some embodiments, the gathering and multicasting of HTTP data to be preloaded into the HTTP proxy 205.

The transparent proxy services provide numerous advantages over the conventional approach. The services of the Transparent Proxy eliminate the need to pre-configure browsers on the PC host to access an HTTP proxy residing on that host. Also, no reconfiguration of the browsers on LAN clients is needed to access an HTTP proxy residing on the host 201.

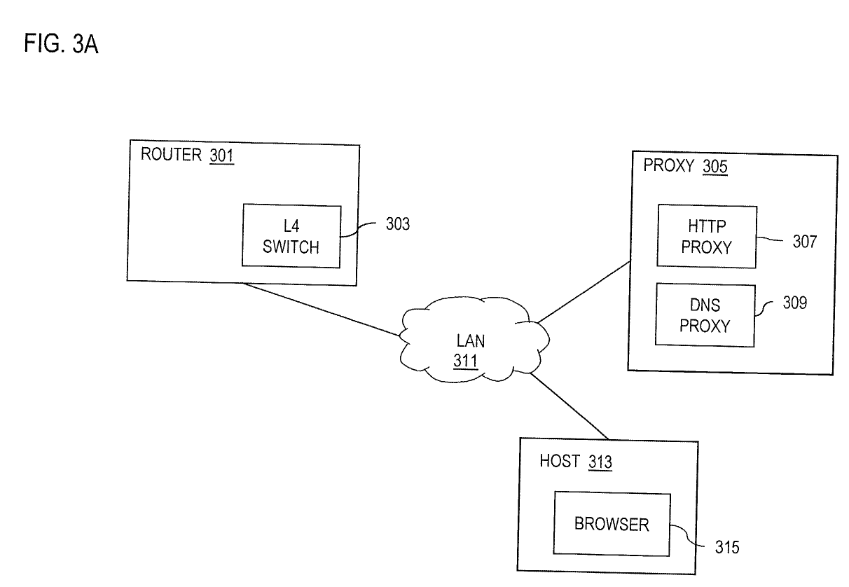

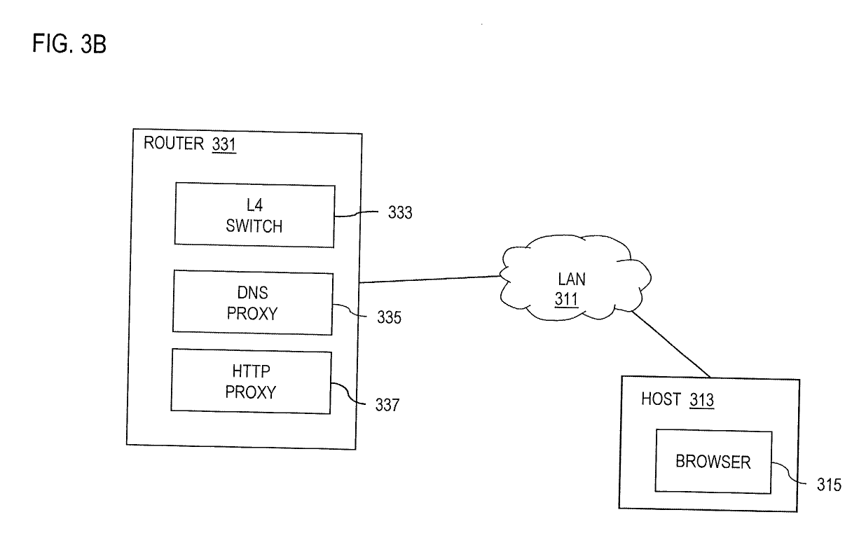

It is recognized that in an alternative embodiment, the Layer 4 switch 215, along with the HTTP proxy 203 and the DNS proxy 205, may reside in the satellite modem 219, as described in FIG. 3B. Additionally, the Layer 4 switch 215 may be implemented in a network element that is separate from the host 201, such as a router—this configuration is described with respect to FIG. 3A, below.

FIG. 3A shows a diagram of an architecture for providing transparent proxying in a network device, such as a router, in accordance with an embodiment of the present invention. As shown, the transparent proxy services can be implemented over separate network elements. A router 301 may house a Layer 4 switch 303, and a proxy server 305 may provide an HTTP proxy 307 and a DNS proxy 309. Both the proxy server 305 and the router 301 are connected to a LAN 311. Unlike the host 201 of the system of FIG. 2, a host 313 contains only a web browser 315. Under this arrangement, the configuration of the host 313 is simplified vis-àa-vis the host 201.

In this scenario, the browser 315 submits a request, for example a HTTP GET, which is transmitted over the LAN 311 to the Layer 4 switch 303 of the router 301. Upon identifying the request (by examining the destination address and destination port), the Layer 4 switch 303 forwards the HTTP request to the HTTP proxy 307 by modifying the addressing information. As a result, the response from the HTTP proxy 307 is returned through the Layer 4 switch; at this point, the Layer 4 switch 303 identifies the TCP connection control block, modifies the packet's addressing information and forwards the response to the browser 315.

FIG. 3B is a diagram for an architecture for providing transparent proxying in a network device, such as a satellite access router, in which the transparent switch and the proxies reside in the access router. Under this approach, the browser 315 submits a URL request, and initiates a DNS lookup—assuming the browser 315 does not provide a translation of the server's domain name to IP address. This DNS request is transmitted over LAN 311 to a router 331 and is processed by a Layer 4 switch 333. Upon identifying the request (i.e., by examining the destination address and destination port), the Layer 4 switch 333 forwards the DNS request to a DNS proxy 335 by modifying the packet's addressing information. As a result, the response from the DNS proxy 335 is returned through the Layer 4 switch. Next, the Layer 4 switch 333 identifies the original source of the DNS request and modifies the response's addressing information and forwards the response back to host 313 and its browser 315.

FIG. 4 is a flow diagram of a Domain Name Service (DNS) request in a transparent proxying architecture, in accordance with the embodiment of the present invention found in FIG. 1. The minor modifications of this diagram to support other embodiments, including FIGS. 2, 3 and 3a should be apparent to one skilled in the art and are discussed at a high level in the text that follows. For the purposes of explanation, it is assumed that the system 100 of FIG. 1 utilizes a Layer 4 switch in the router 111 and the proxy server 113 behaves as a DNS proxy and the each machine supports the UDP. In step 401, the web browser in the host 101 submits a DNS Request for the DNS server 117. The DNS Request, in this example, specifies a source address of “Local IP” (i.e. the address of the host 101) and a destination address of “DNS IP” (i.e. the address of DNS server 117); in which the source port is “A” and the destination port is “53”. The Layer 4 Switch within the router 111 recognizes the DNS request by its destination port and routes, as in step 403, the request to the DNS proxy 113. The DNS request, at this point, is altered, whereby the source address is the “DNS IP” and the destination address is the “Proxy IP”; the source port is modified from port “A” to a Layer 4 pool port “P” and the destination port is “DNS proxy port X.” The DNS proxy stores in a record associated with port “P” the original source IP address and port of the request so that it can restore those values into the destination address and port of the DNS response in step 409 as discussed below.

This source address is changed only when the Layer 4 switch and DNS proxy are on same machine, otherwise, the source address else it is left unchanged. If the requested DNS is in the DNS proxy cache of the DNS proxy, then a DNS response is sent back. However, if there is a cache miss, then the DNS request is sent to the DNS server 117, per step 405. In the case of a cache miss, the source address of the DNS request is changed from “DNS server IP” to “DNS proxy IP”, and the source port is changed from “P” to “X” where “X” is a value known to the layer 4 switch and reserved for use by the DNS proxy 113. The destination port is changed to “53” (the DNS request server port) so that the DNS server will process the request. Because the request is from port “X” and destination port is “53,” the Layer 4 Switch would let the request pass. The Layer 4 switch would only intercept the packets with destination port “53” and source port all except proxy port “X.” In step 407, the DNS response received from the DNS Server 117 updates the DNS cache. The DNS response specifies the source address as “DNS Server IP”, the destination address as “Proxy IP”, the source port as “53”, and the destination port as “X”. Next, the DNS proxy sends the DNS response to the browser through the Layer 4 Switch, per steps 409 and 411. The DNS response from the DNS proxy server to the Layer 4 switch has the following parameters: a source address of “Proxy IP”, a destination address of “DNS IP”, a source port of “X”, and a destination port of “P.” The DNS response at the browser specifies a source address of “DNS Server IP”, a destination address of “Local IP”, a source port of “53”, and a destination port of “A.”

It is noted that a Layer 4 switch may be implemented in any network element that has access to the packets which are traversing the Wide Area Network (101). According to one embodiment of the present invention, the DNS proxy is utilized in one device, such as the proxy server 305; under such a scenario, all the Layer 4 switches are configured to the same DNS proxy IP and Port. As can be understood by one skilled in the art, the exact details of the modification of the addressing information and other fields of the request and response packets may be modified in other embodiments is such a way that the essence of the transparent switching is retained. This essence is that the request is redirected to the proxy and the response from the proxy is redirected to the originator of the request in a way that makes it appear that it came from the DNS server.

The Layer 4 switch needs to know whether the configured Proxy address is a local IP or non-local. If it is a local IP (i.e., the Layer 4 switch) and DNS proxy reside on the same machine (as is the case of the host 201 of FIG. 2), then the layer 4 switch sends the packet up the protocol stack to the proxy. If the DNS configured IP is non-local, the packet is sent down towards the network. Thus, one of two different paths for the DNS request from the Layer 4 switch exists depending on the specific embodiment of the invention. If the packet needs to be sent out on the network, the source address would not be changed to the DNS Server IP address, thus ensuring that the DNS proxy sends back the response to the DNS request back to the Layer 4 switch of the originating DNS request. In addition to the DNS proxy services, the present invention also supports HTTP proxy services, as next discussed in FIG. 5.

FIG. 5 is a flow diagram of a connection establishment request via a HyperText Transfer Protocol (HTTP) in a transparent proxying architecture, in accordance with an embodiment of the present invention. In this example, the HTTP proxy service is described with respect to the system of FIG. 1, wherein the proxy server 113 is assumed to be an HTTP proxy server. The minor modifications of this diagram to support other embodiments, including FIGS. 2, 3 and 3a should be apparent to one skilled in the art and are discussed at a high level in the text that follows. In step 501, a browser within the host 101 issues a Connection Establishment request (e.g., a SYN request) to the web server 105. The SYN request from the browser specifies, for example, a source address of “Local IP” (i.e. host 101's address), a destination address of “IS IP” (corresponding to the web server 105), a source port of “A”, and a destination port of “80” (corresponding the HTTP protocol's server port). Next, in step 503, the request for the web server 105 is routed to an HTTP Proxy 113; the SYN request is modified as follows: source address is changed from “Local IP” to “IS IP”, source port from “A” to “Pool Port P”, destination address from “IS IP” to “Proxy IP,” and destination port from “80” to “Proxy Port Y.” A Connection response (i.e., SYN response) from the HTTP proxy server 113 is routed to a Layer 4 switch, per step 505. The SYN response specifies a source address of “Proxy IP”, a destination address of “IS IP”, a source port of “Proxy Port Y”, and a destination port of “L4 Pool Port.” The Layer 4 switch modifies the SYN response as follows: source address from “Proxy IP” to “IS IP,” source port from “Proxy Port Y” to “80,” a destination address from “IS IP” to “Local IP,” and destination port from “Pool Port P” to port “A”. In step 507, this response from the Layer 4 switch is routed to the browser with the addressing modified so that the response appears to have originated from the web server 105. Other request and response packets for this TCP connection are similarly handled by the Layer 4 switch so that the connection is actually routed to the HTTP proxy server 113 but so that it appears to the browser that the connection is to web server 105. In order to do the restoral of the addressing performed step 507 above, the Layer 4 Switch maintains a TCP connection control block for each of the switched connections containing the original source IP address and port number for the connection. This control block is indexed by Pool Port P.

The processes of FIGS. 4 and 5 accordingly provide transparent forwarding of DNS requests and HTTP requests, respectively, without the need to configure the web browser on the client host.

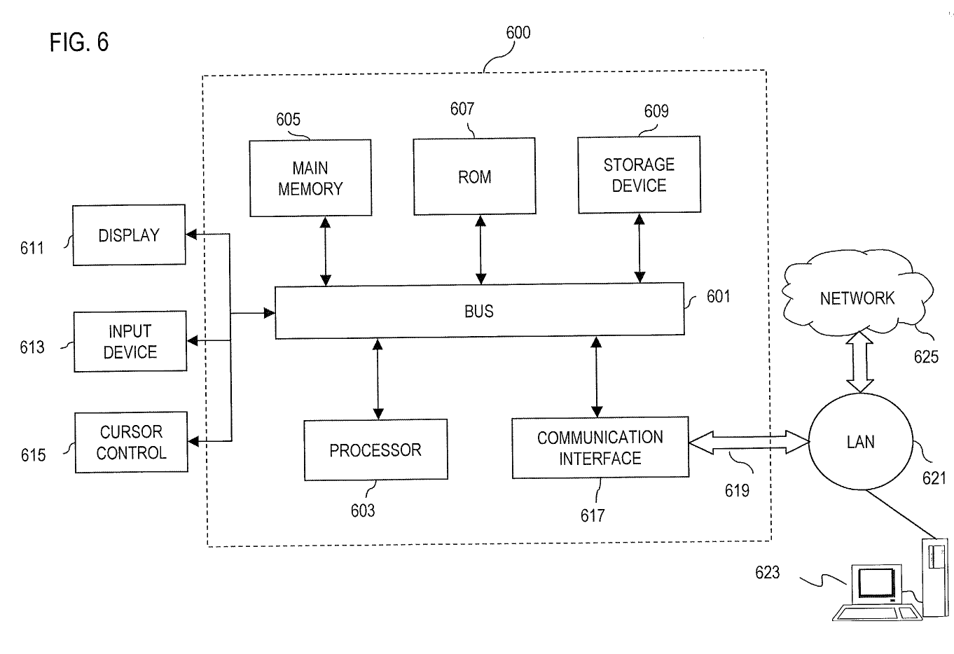

FIG. 6 illustrates a computer system 600 upon which an embodiment according to the present invention can be implemented. The computer system 600 includes a bus 601 or other communication mechanism for communicating information, and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions to be executed by the processor 603. The computer system 600 further includes a read only memory (ROM) 607 or other static storage device coupled to the bus 601 for storing static information and instructions for the processor 603. A storage device 609, such as a magnetic disk or optical disk, is additionally coupled to the bus 601 for storing information and instructions.

The computer system 600 maybe coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is cursor control 615, such as a mouse, a trackball, or cursor direction keys for communicating direction information and command selections to the processor 603 and for controlling cursor movement on the display 611.

According to one embodiment of the invention, transparent proxying is provided by the computer system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. Thus, embodiments of the present invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, or a telephone modem to provide a data communication connection to a corresponding type of telephone line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by service provider. The local network 621 and network 625 both use electrical, electromagnetic, or optical signals to convey information and instructions. The signals through the various networks and the signals on network link 619 and through communication interface 617, which communicate digital data with computer system 600, are exemplary forms of carrier waves bearing the information and instructions.

The computer system 600 can send messages and receive data, including program code, through the network(s), network link 619, and communication interface 617. In the Internet example, a server (not shown) might transmit requested code belonging an application program for implementing an embodiment of the present invention through the network 625, local network 621 and communication interface 617. The processor 604 may execute the transmitted code while being received and/or store the code in storage device 69, or other non-volatile storage for later execution. In this manner, computer system 600 may obtain application code in the form of a carrier wave.

The term “computer-readable medium” as used herein refers to any medium that participates in providing instructions to the processor 604 for execution. Such a medium may take many forms, including but not limited to non-volatile media, volatile media, and transmission media. Non-volatile media include, for example, optical or magnetic disks, such as storage device 609. Volatile media include dynamic memory, such as main memory 605. Transmission media include coaxial cables, copper wire and fiber optics, including the wires that comprise bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, the present invention addresses the above stated needs by providing a proxy architecture that enhances network performance by transparently routing HTTP and DNS look-ups to corresponding proxies. Notably, a Layer 4 switch is provided to route an HTTP request or a DNS request to the respective HTTP proxy and DNS proxy; the Layer 4 switch supports forwarding of the requests that is transparent to the browser, which originates such requests. The above arrangement advantageously enhances system performance, while avoiding the need to pre-configure client software.

While the present invention has been described in connection with a number of embodiments and implementations, the present invention is not so limited but covers various obvious modifications and equivalent arrangements, which fall within the purview of the appended claims.

What is claimed is:

1. A method for providing a proxy service, the method comprising:
receiving a message from an application that supports browsing, the message being identified as invoking the proxy service; and
selectively forwarding the message to a proxy agent configured to provide the proxy service,
wherein the forwarding of the message is transparent to the application.

2. A method according to claim 1, wherein the proxy agent in the forwarding step includes at least one of a HyperText Transfer Protocol (HTTP) proxy and a Domain Name Server (DNS) proxy.

3. A method according to claim 1, wherein the forwarding step is performed by a switching mechanism that is configured to switch the message according to a predetermined protocol that operates above a network layer.

4. A method according to claim 3, wherein the switching mechanism resides in a host that is loaded with the application.

5. A method according to claim 3, wherein the switching mechanism resides in a network element that is configured to perform routing of the message.

6. A method according to claim 3, wherein the switching mechanism resides in a modem that is configured to communicate over a satellite network.

7. A method according to claim 1, wherein the proxy agent resides in at least one of a host loaded with the application, a satellite modem, and a network element configured to perform routing of the message.

8. A method according to claim 1, wherein the message is transmitted over a wide area network (WAN) that includes a two-way satellite network.

9. A network apparatus for providing a proxy service, comprising:
switching logic configured to receive a message from an application that supports browsing and to identify the message as invoking the proxy service,
wherein the switching logic selectively forwards the message to a proxy agent configured to provide the proxy service, the forwarding of the message being transparent to the application.

10. An apparatus according to claim 9, wherein the proxy agent includes at least one of a HyperText Transfer Protocol (HTTP) proxy and a Domain Name Server (DNS) proxy.

11. An apparatus according to claim 9, wherein the switching logic is configured to switch the message according to a predetermined protocol that operates above a network layer.

12. An apparatus according to claim 9, further comprising:
a communication interface coupled to the switching logic and configured to communicate with a modem that is configured to communicate over a satellite network.

13. An apparatus according to claim 12, wherein the proxy agent resides in at least one of the satellite modem, and a network element configured to perform routing of the message.

14. An apparatus according to claim 9, wherein the message is transmitted over a wide area network (WAN) that includes a two-way satellite network.

15. A communication system for supporting a proxy service, the system comprising:
a host loaded with an application that supports browsing, the application outputting a message requesting information; and
a network element configured to receive the message from the host and to identify the message as invoking a proxy agent to perform the proxy service, the network element includes a switching mechanism to selectively forward the message to the proxy agent, the forwarding of the message being transparent to the application of the host.

16. A system according to claim 15, wherein the proxy agent includes at least one of a HyperText Transfer Protocol (HTTP) proxy and a Domain Name Server (DNS) proxy.

17. A system according to claim 15, wherein the switching mechanism is configured to switch the message according to a predetermined protocol that operates above a network layer.

18. A system according to claim 15, wherein the message is transmitted over a wide area network (WAN) that includes a two-way satellite network.

19. A computing device for supporting a proxy service, comprising:
means for receiving a message identified as invoking the proxy service from an application that supports browsing; and
means for selectively forwarding the message to a proxy agent configured to provide the proxy service,
wherein the forwarding of the message is transparent to the application.

20. A device according to claim 19, wherein the proxy agent includes at least one of a HyperText Transfer Protocol (HTTP) proxy and a Domain Name Server (DNS) proxy.

21. A device according to claim 19, wherein the forwarding means includes a switching means for switching the message according to a predetermined protocol that operates above a network layer.

22. A device according to claim 19, wherein the message is transmitted over a wide area network (WAN) that includes a two-way satellite network.

23. A computer-readable medium carrying one or more sequences of one or more instructions for providing a proxy service, the one or more sequences of one or more instructions including instructions which, when executed by one or more processors, cause the one or more processors to perform the steps of:
receiving a message from an application that supports browsing, the message being identified as invoking the proxy service; and
selectively forwarding the message to a proxy agent configured to provide the proxy service,
wherein the forwarding of the message is transparent to the application.

24. A computer-readable medium according to claim 23, wherein the proxy agent in the forwarding step includes at least one of a HyperText Transfer Protocol (HTTP) proxy and a Domain Name Server (DNS) proxy.

25. A computer-readable medium according to claim 23, wherein the forwarding step is performed by a switching mechanism that is configured to switch the message according to a predetermined protocol that operates above a network layer.

26. A computer-readable medium according to claim 25, wherein the switching mechanism resides in a host that is loaded with the application.

27. A computer-readable medium according to claim 25, wherein the switching mechanism resides in a network element that is configured to perform routing of the message.

28. A computer-readable medium according to claim 25, wherein the switching mechanism resides in a modem that is configured to communicate over a satellite network.

29. A computer-readable medium according to claim 23, wherein the proxy agent resides in at least one of a host loaded with the application, a satellite modem, and a network element configured to perform routing of the message.

30. A computer-readable medium according to claim 23, wherein the message is transmitted over a wide area network (WAN) that includes a two-way satellite network.

31. A network apparatus for providing a proxy service, comprising:
switching logic configured to receive a message from an application that supports browsing and to identify the message as invoking the proxy service; and
a proxy agent configured to provide the proxy service,
wherein the switching logic selectively forwards the message to the proxy agent, the forwarding of the message being transparent to the application.

32. An apparatus according to claim 31, wherein the proxy agent includes at least one of a HyperText Transfer Protocol (HTTP) proxy and a Domain Name Server (DNS) proxy.

33. An apparatus according to claim 31, wherein the switching logic is configured to switch the message according to a predetermined protocol that operates above a network layer.

34. An apparatus according to claim 31, further comprising:
a communication interface coupled to the switching logic and configured to communicate with a modem that is configured to communicate over a satellite network.

35. An apparatus according to claim 31, wherein the message is transmitted over a wide area network (WAN) that includes a two-way satellite network.
